(19) United States
(12) Patent Application Publication
(10) Pub. No.: US 2010/0306642 A1
(43) Pub. Date: Dec. 2, 2010

(54) CO-BROWSING (JAVA) SCRIPTED HTML DOCUMENTS

(75) Inventors: Dietwig J.C. Lowet, Eindhoven (NL); Pieter Lambooij, Eindhoven (NL); Jurgen K. Muller, Eindhoven (NL); Paul Shrubsole, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,975

(22) PCT Filed: Nov. 18, 2008
(86) PCT No.: PCT/IB2008/054823

§ 371 Date: Aug. 5, 2010

(30) Foreign Application Priority Data
Nov. 23, 2007 (EP) 07121404.3

(51) Int. Cl. G06F 3/01; G06F 17/00

(52) U.S. Cl. 715/234; 715/760

(57) ABSTRACT

A method for collaboratively browsing the content of a dynamic electronic document innetwork comprising a first (210) and a second (210′) Web browser. The method comprises the steps of: retrieving dynamic Web page content including a Web application script, detecting a user input event in any of the browsers, executing, in the first browser (210), a co-browsing script which includes generating an update message in dependence of the user input event, sending, from the first browser (210) to the second browser (210′), the update message, executing, in the first browser (210), the Web application script which includes updating the content of the electronic document in the first Web browser (210′) in dependence of the update message or the user input event, and updating, in the second browser (210′), the content of the electronic documentin the second Web browser in dependence of the update message.

Present invention relates to a method for collaboratively browsing the content of an electronic document in a network comprising at least two Web browsers.

Co-browsing is the act of two or more people located geographically at different places to browse HTML documents in a synchronized way, such that each participant has the same view of the HTML document.

There are many application areas for HTML web pages were sharing a common view is interesting, for example viewing and annotating pictures together, choosing a movie together on a movie theatre web site, online shopping together, playing a game together, navigating maps for planning a route together, etc. A co-browsing application typically includes a communication frame and possibly a separate frame for private browsing. But central in every co-browsing application is a shared frame, which is synchronized between the different co-browsers. Today several methods exist for co-browsing a HTML document.

U.S. Pat. No. 6,871,213, for example, describes a method and system for exchanging information over a communications network. According to one embodiment, an exemplary method of the invention includes connecting two or more clients to a proxy over the communications network, activating a shared session between the clients, and enabling co-navigation of one or more web documents with dynamic content by the clients during the shared session.

US-2002/138624 describes a computerized system that enables multiple users of standard Internet web browsers to collaborate by having significant states of their browser, such as which web page is currently being viewed, scrollbar positions, and form values, to be remotely controlled by users of other Internet web browsers. The system uses a monitor to poll the static and dynamic state of the selected pages, and to communicate the state with a controller executing on a web server. The content of the collaboratively viewed pages is arbitrary because viewed pages remain unmodified. Therefore, pre-existing web pages can be collaboratively browsed. Each of the users is optionally a sender or a receiver of selected web pages, and therefore is allowed to control which web pages are collaboratively viewed.

U.S. Pat. No. 6,151,622 describes another method for synchronizing views among a plurality of different Web browsers in a network environment, and includes selecting a source root frame displayed by a source browser included in the plurality of different web browsers and generating a description of a frame hierarchy from the selected source root frame. The description of a frame hierarchy is transmitted over the network environment and the frame hierarchy duplicated from the description into a selected target root frame of at least one of the plurality of different Web browsers.

To avoid the adaptation of all these single-user services to allow them to be (occasionally) shared, there is a need for a generic mechanism for synchronizing HTML services between two or more clients. As mentioned, this is referred to as “co-browsing” or “shared browsing”. Prior art co-browsing solutions relates to synchronization of static web pages, but has the drawback of not being able to efficiently synchronize web sessions making extensive use of, for example, JavaScript and Ajax interactions.

It is an object of the present invention to provide an improvement of the above techniques and prior art. A particular object is to provide efficient co-browsing of dynamic Web pages, i.e. Web pages scripted by means of e.g. JavaScript.

These and other objects as well as advantages that will be apparent from the following description of the present invention are achieved by a method according to the independent claim. Preferred embodiments are defined in the dependent claims.

Hence a method is provided for collaboratively browsing the content of a dynamic electronic document in network comprising at least a first Web browser and a second Web browser, the method comprising the steps of:

retrieving, from a Web site, dynamic Web page content comprising at least one Web application script,

detecting a user input event at any of the browsers,

executing, in the first browser, a co-browsing script which includes generating an update message in dependence of the user input event, the update message representing an update of the Web page content,

sending, from the first browser to the second browser, the update message,

executing, in the first browser, the Web application script which includes updating the content of the electronic document in the first Web browser in dependence of the update message or the user input event, and

updating, in the second browser, the content of the electronic document in the second Web browser in dependence of the update message, so as to synchronize the Web page content of the first and second Web browser.

The inventive method is advantageous in that it allows co-browsing of scripted Web page content, or scripted HTML documents. Current state-of-the art co-browsing solutions only allow or provide a method for sharing static HTML documents, i.e. documents that do not contain a script, in particular a JavaScript. Co-browsing of dynamic Web pages is not really described, but instead co-browsing methods using URL pushing, synchronizing scroll actions and synchronizing the window size.

Nowadays a large part, if not the majority, of web pages contain JavaScript. Also partly due to the widespread support of Ajax (XMLHttpRequest) technology in current browsers, which enables the JavaScript to retrieve additional information from the backend server without a Web page update, many java scripted Web pages are in fact better described as an application rather than a HTML document. Well known examples here are googlemaps, flickr.com and writely.com. Some Web sites even consist only of JavaScript and the complete HTML tree is built up at the client side via JavaScript. Using current state of the art co-browsing solutions to synchronize these java scripted web pages documents/applications is not possible. However, present invention discloses an applicable method for this purpose.

It should be noted that the term in “dependence of” has a meaning that corresponds to the term “using as an input”. For example, generating an update message in dependence of the user input event means generating an update message by using the user input event as input.

The content of the electronic document may be represented by a Document Object Model (DOM), the update message comprising a Document Object Model update. It should be noted that the term DOM in this context is used both as the abstract representation of the HTML document that is rendered by the browser, as well as the application programming interface that JavaScript can use to make changes to this HTML document and receive events.

The first Web browser may be a reference browser, the step of detecting a user input event may include detecting the event in the second Web browser and sending it to the first Web browser, the step of sending the update message may include sending the update message from the first browser to a third browser, the step of updating the content of the electronic document in the second Web browser may include updating content of the electronic document in the third Web browser in dependence of the update message, so as to synchronize the Web page content of the first, second and third Web browser, the updating of the content of the electronic document in the second and third Web browser may include updating the Document Object Model in dependence of the Document Object Model update message.

The step of detecting a user input event may include sending the detected user input event to an event ordering service, and transferring, according to a synchronization scheme, the user input event to the first Web browser.

The step of detecting the user input event may include detecting the event in the first Web browser, the step of executing the Web application script may include updating the Document Object Model in the first Web browser, and the step of updating the content of the electronic document in the second Web browser may include updating the Document Object Model in dependence of the update message.

The step of sending the update message from the first browser to the second browser may include sending the update message via a message forward service.

The update message may comprise the user input event.

The step of updating the graphical content in the second browser may include executing, in the second browser, the Web application script which includes updating the content of the electronic document in the second Web browser in dependence of the update message.

The steps of executing the Web application script may comprise updating the Document Object Model in the first and second Web browser.

The step of sending the update message from the first browser to the second browser may include sending the update message via a message forward service.

The step of detecting a user input event may include sending the detected user input event to an event ordering service, and transferring, according to a synchronization scheme, the user input event to the first Web browser and to the second Web browser.

The Web browsers may be connected to the Web site via a proxy server.

The method may further comprise the step of sending, from the first browser to the second browser, markup language code describing the Web page content.

The method may further comprise the step of selectively disabling user input at one of the browsers.

The Web page may comprise HTML nodes, and the method may further comprise the step executing a computer script configured to assign, to each HTML node, a unique identifier.

Embodiments of the present invention will now be described, by way of example, with reference to the accompanying schematic drawings, in which

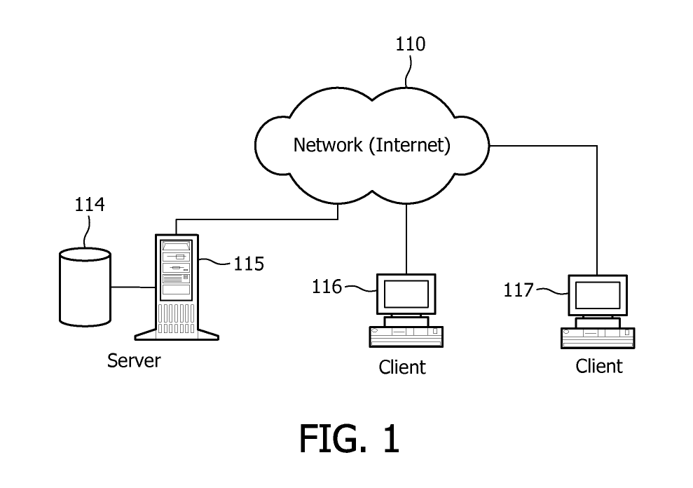

FIG. 1 is a representation of a data processing system which may be used for implementing the present invention,

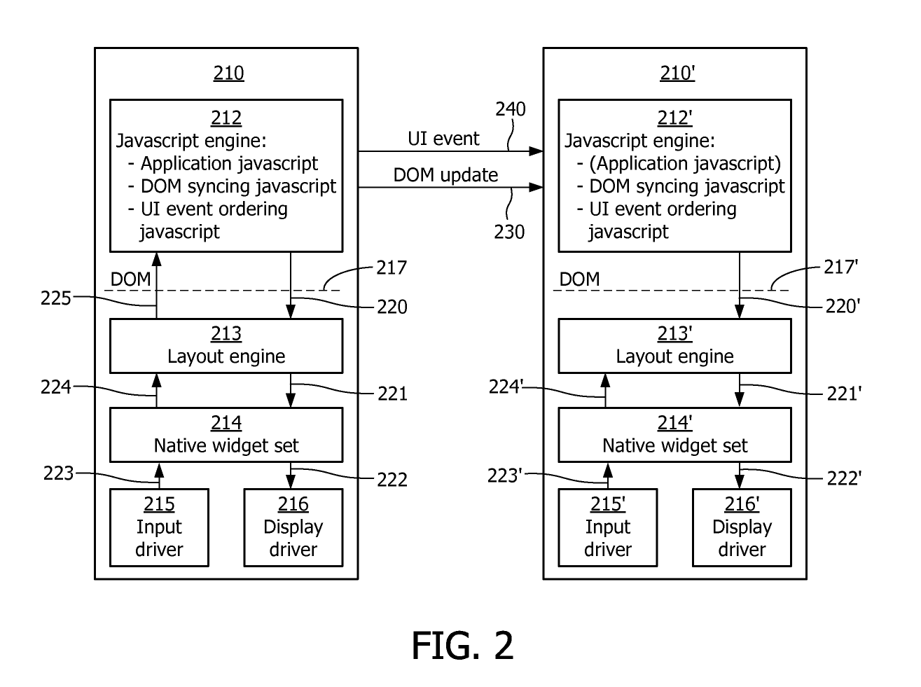

FIG. 2 is a schematic view of two Web browsers according to the invention,

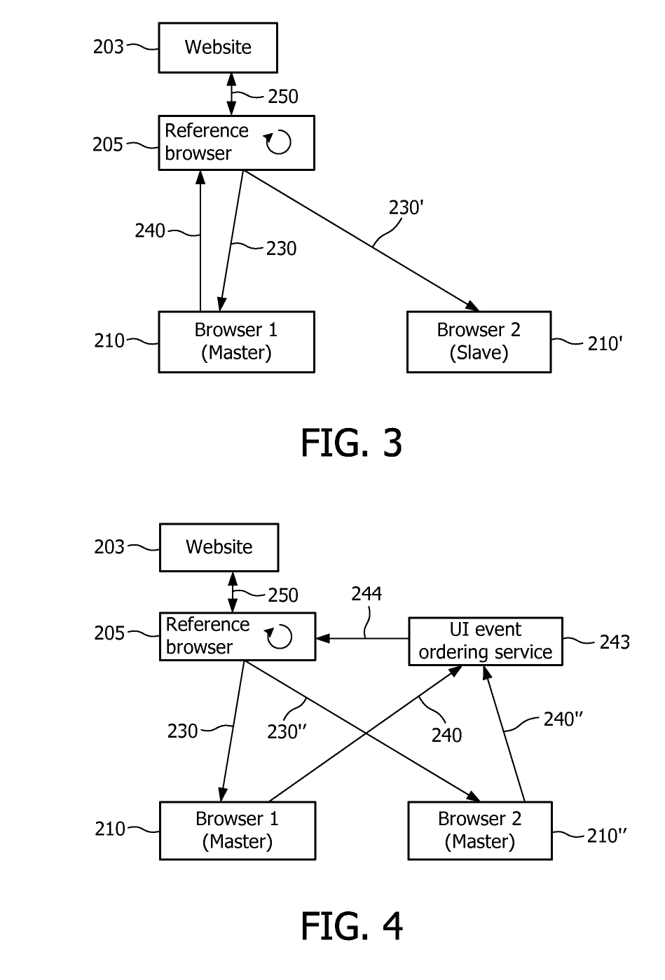

FIGS. 3-10 are a block diagrams of distributed collaborative web-browsing systems according to six different embodiments that implement the inventive method,

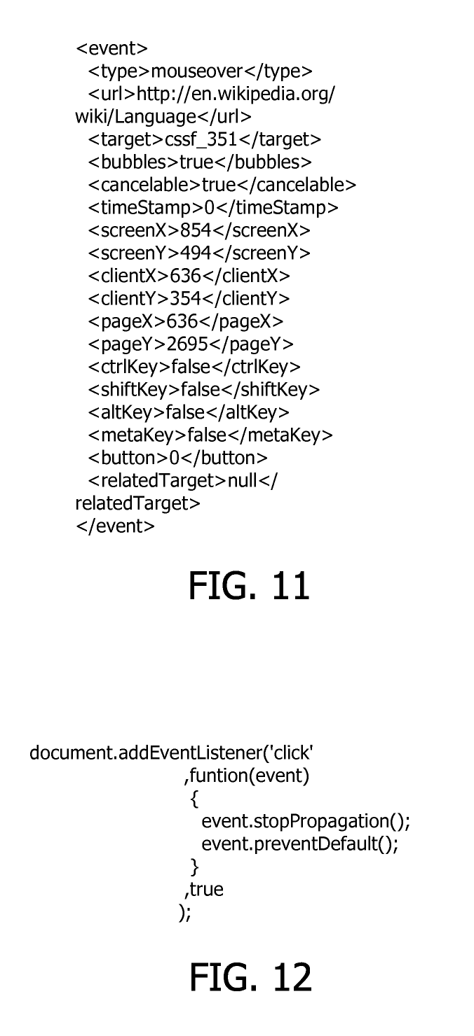

FIGS. 11 and 12 shows pseudo-code, and

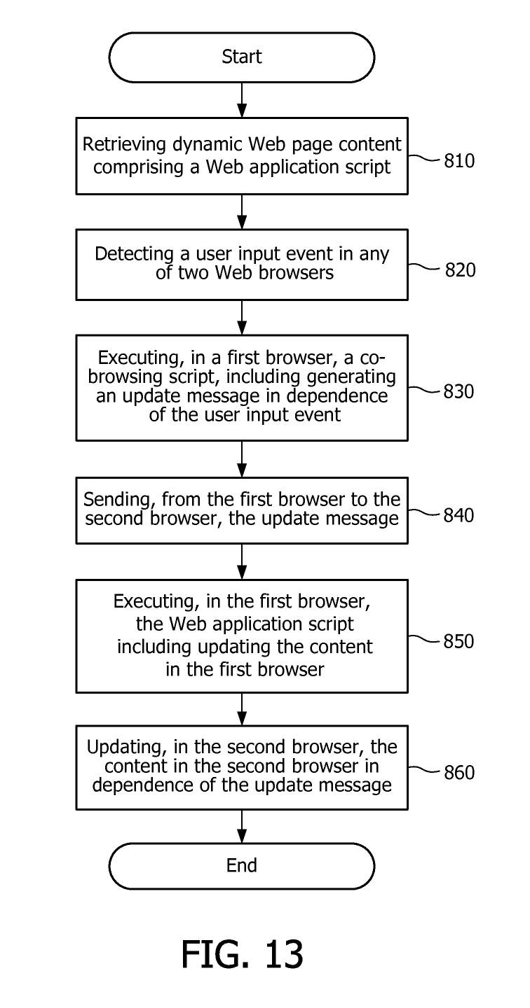

FIG. 13 is flow diagram of the inventive method.

With reference to FIG. 1, a conventional data processing system is illustrated which may be used for implementing the present invention. The system includes a server (host) computer system 115 with a data storage 114 for storing dynamic Web page content comprising at least one Web application script. The server 115 and several client computer (clients) systems 116, 117 are connected to each other by a network 110. The clients 116, 117 may be workstations, personal computers, personal digital assistants, mobile telephones and the like executing software programs. Operating system software may be Windows, LINUX etc. and application software includes Internet applications such as Web browsers. The server 115 executes server software and the network is, for example, the Internet 110 including the World-Wide-Web. The network may also include intermediate routers and proxy servers.

FIG. 2 illustrates generically two Web-browsers 210, 210′ which are executed on a respective computer, such as on a server or client according to the above description. Each browser 210, 210′ has a JavaScript engine 212, 212′ that generates a document object model (DOM) 217, 217′ which is a platform- and language-independent standard object model for representing HTML, CE-HTML or XML and related formats, i.e. the DOM is the representation of what is shown inside a browser window. The DOM is per se known within the art and is required by JavaScript scripts that wish to inspect or modify a web page dynamically, i.e. the Document Object Model is the way JavaScript sees its containing HTML page and browser state and at the same time it is an application programming interface to make changes to the HTML document.

The first browser 210 comprises a layout engine 213, a native widget set 214, an input driver 215 and a display driver 216, which cooperate in a manner known within the art. In brief, the JavaScript engine 212 is configured to send a DOM update 220 to the layout engine 213, which sends an update 221 to the native widget set which in turn sends an update 222 to a display driver for displaying the update for a user.

The user interacts with the Web browser 210 by means of an input driver 215 which generates a user input (UI) event 223 that reflects a user action. The UI event 223 is sent to the native widget set 214 which sends a native UI event 224 to the layout engine 213.

The second browser 210′ comprises corresponding features, which are indicated by like reference numerals but with a prim-sign. However, in the first browser 210 the layout engine 213 sends to the JavaScript engine 212 a JavaScript user interface event 225 that represents the UI event 223. The JavaScript user interface event 225 is processed by the JavaScript engine 212 and a corresponding DOM update is generated and sent to the layout engine 213. In this manner the dynamic Web page content is continuously updated in dependence of user action.

The JavaScript engine 212 executes the JavaScript of the co-browsed web application and DOM synchronizing JavaScript code. The JavaScript engine 212 comprises an application JavaScript, which is used to render the Web page in the browser, and a DOM synchronizing JavaScript. This synchronizing JavaScript sends to the second browser 210′, which is a slave browser, DOM updates 230 that correspond to the DOM updates sent to the layout engine 213 in the first browser 210, which in this case is the master browser. No UI events in the slave browser 210′ are inserted in any of the JavaScript engines 212, 212′. When a DOM update is sent to the slave browser 210′ the application JavaScript is not executed in the slave browser 210′ but instead the DOM update is directly applied by the DOM synchronizing JavaScript of the slave browser 210′, and, accordingly, is the two browsers synchronized which facilitates co-browsing.

In other words, when synchronizing by sending DOM updates the JavaScript engine of the master browser updates the DOM and the DOM updates are sent to the co-browser. On the master browser the JavaScript of the web application runs as normal. On both sides an extra piece of JavaScript is added to synchronize the DOM. The DOM synchronization JavaScript on the master browser keeps track of DOM changes and sends them over to the slave browser. On the slave browser the DOM synchronization JavaScript listens for incoming DOM changes and uses the DOM interface to adapt the DOM of the slave browser. In this solution only the master browser communicates with the web server that servers the HTML/CE-HTML pages. Switching the master slave role in this option would involve sending over the JavaScript engine state from the master to the slave and initialize the JavaScript engine from the slave browser with the received master JavaScript engine state.

Instead of, or as a complete to DOM synchronization, a JavaScript user interface events (UI event) 240 is sent from the first browser 210 to the second browser 210′. In this case the application JavaScript is executed in the slave browser 210′ having the UI event 240 as input, which, in the slave browser 210′, generates a DOM update.

In other words, when synchronizing by sending UI events, the method relies on keeping the JavaScript engines in all the co-browsers in sync, and thus indirectly also the DOM. In order to do this all user events injected by the layout engine in to the JavaScript engine of the master browser must be also be injected into the JavaScript engine of the slave browser. This means that all the JavaScript engines are running and that only “JavaScript UI events” must be sent over. Here the term JavaScript UI events indicate the events that the browser generates and sends to the JavaScript engine as defined in the DOM specification. In both browsers the normal JavaScript of the web application is executed. On the master browser, UI event synchronization JavaScript is added which listens to all incoming UI events and sends them over to the slave browser. On the slave browser, UI event synchronization JavaScript is added that disables the UI events coming from the local input devices but instead listens for incoming JavaScript UI events from the master browser. The incoming UI events from the master browser are recreated and dispatched again to be processed by the JavaScript of the web application.

All changes made to the web document by JavaScript are done through the document object, which implements the DOM interface. The JavaScript engines are, as described, not by per se required to be synchronized, because all a JavaScript engine does is make changes to the DOM. The fundamental requirement for synchronizing two browsers is that the DOM should be synchronized. This leads to the two main options described above for synchronizing scripted web documents.

FIG. 3 illustrates a first embodiment of implementing the co-browsing system, which is based on a backend reference browser 205 with DOM updates (master-slave). The roundabout arrow in a browser indicates that the web application's JavaScript is being executed, otherwise it is not.

All UI events 240 are intercepted by JavaScript and sent to the reference browser 205. The reference browser 205 injects the UI events into its JavaScript engine, the resulting DOM changes 230, 230′ are then forwarded to the co-browsers 210, 210′. This is a very robust solution, but might lower user experience for the master 210 because the events first have to go to the reference browser 205 and be processed there before the user receives avy feedback.

The reference browser 205 communicates with a Web server 203 in a conventional manner by sending client-server message 250, which also applies for the embodiments described below.

FIG. 4 illustrates a version of the first embodiment, where two co-browsers act as master browsers 210, 210″. In this case UI events 240, 240″ are sent to a user interface event ordering service 243 which forwards the synchronized UI events 244 to the reference browser 205. The ordering service 243 may operate according to a first UI event in/first UI event out principle.

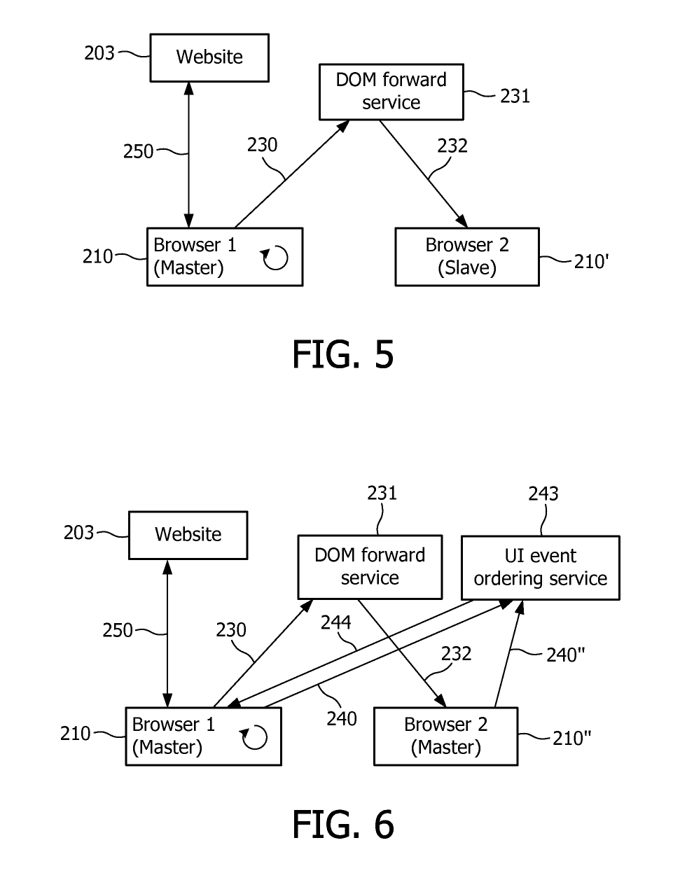

FIG. 5 illustrates a second embodiment of implementing the co-browsing system, which is based on using an on-device reference browser, i.e. one of the co-browsers plays the role of the reference browser 210. Here DOM update 230 is sent to a DOM update forward service 231 which sends a forwarded DOM update 232 to the second browser 210′. The roundabout arrow in a browser indicates that the web application's JavaScript is being executed, otherwise it is not.

To switch the master role, there are two ways. The optimal way is that the JavaScript engine state is sent over the other co-browser, which has now become the master. If sending over the JavaScript engine state is not an option, the new master must first intercept all UI events, send them to the reference browser and than all browsers are updated with the DOM changes.

FIG. 6 illustrates a version of the second embodiment, where two co-browsers act as master browsers 210, 210″. In this case UI events 240, 240″ are sent to a user interface event ordering service 243 which forwards the synchronized UI events 244 to the first browser 210.

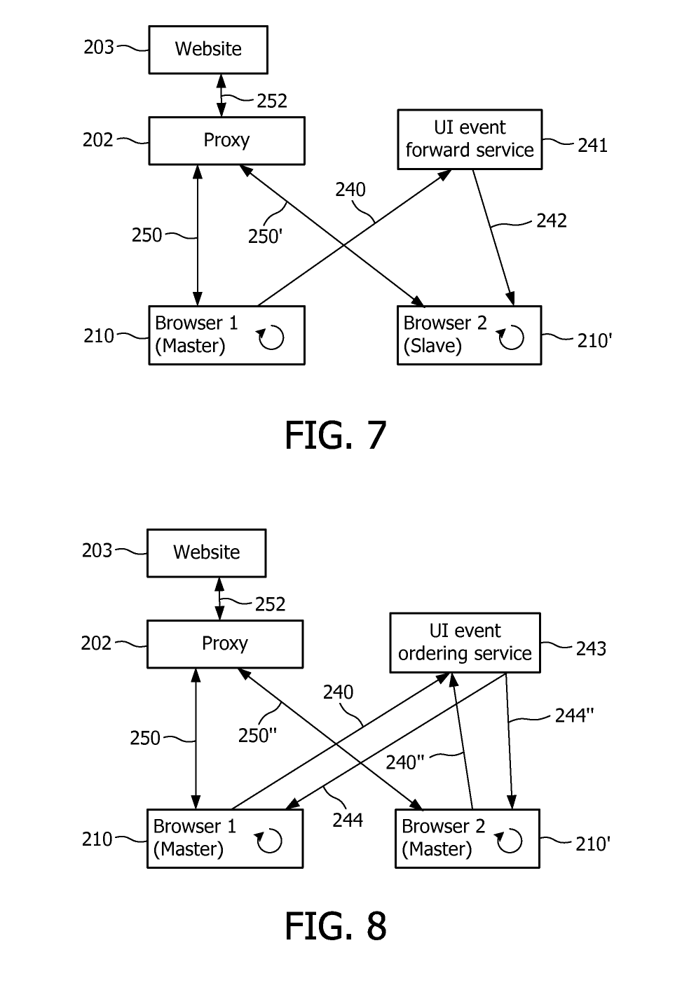

FIG. 7 illustrates a third embodiment of implementing the co-browsing system, which is based on JavaScript UI event synchronization. Here, JavaScript UI events 240 are sent over from the master 210 to a user interface event forward service 241 which sends a forwarded UI event 242 to the slave browser 210′, and the slave browser 210′ inject the events in its JavaScript engine.

Because web sites do not always follow the internet principal that a unique URL represents a unique and specific piece of content, in other words web sites often provide randomized content for the same URL, this version also requires a proxy server 202 in between the co-browsed website service 203, to ensure all co-browsers receive the same content. In this case two client-server messages 250, 252′ are transmitted to the proxy server 202, which forwards a request to 252 the website service 203. Again, the roundabout arrow in a browser indicates that the web application's JavaScript is being executed, otherwise it is not.

FIG. 8 illustrates a version of the third embodiment, where two co-browsers act as master browsers 210, 210″. In this case UI events 240, 240″ are sent to a user interface event ordering service 243 which forwards the ordering UI events 244 to the first and second browser 210, 210″.

The inventive method is illustrated in FIG. 13, and shows the steps of:

retrieving 810, from the Web site 203, dynamic Web page content comprising at least one application script,

detecting 820 a user input event,

executing 830, in the first browser, a co-browsing script which includes generating an update message 230, 240 in dependence of the user input event,

sending 840, from the first browser to the second browser, the update message,

executing 850, in the first browser, the Web application script which includes updating the content of the electronic document in the first Web browser in dependence of the update message or the user input event, and

updating 860, in the second browser, the content of the electronic document in the second Web browser in dependence of the update message, so as to synchronize the Web page content of the first and second Web browser.

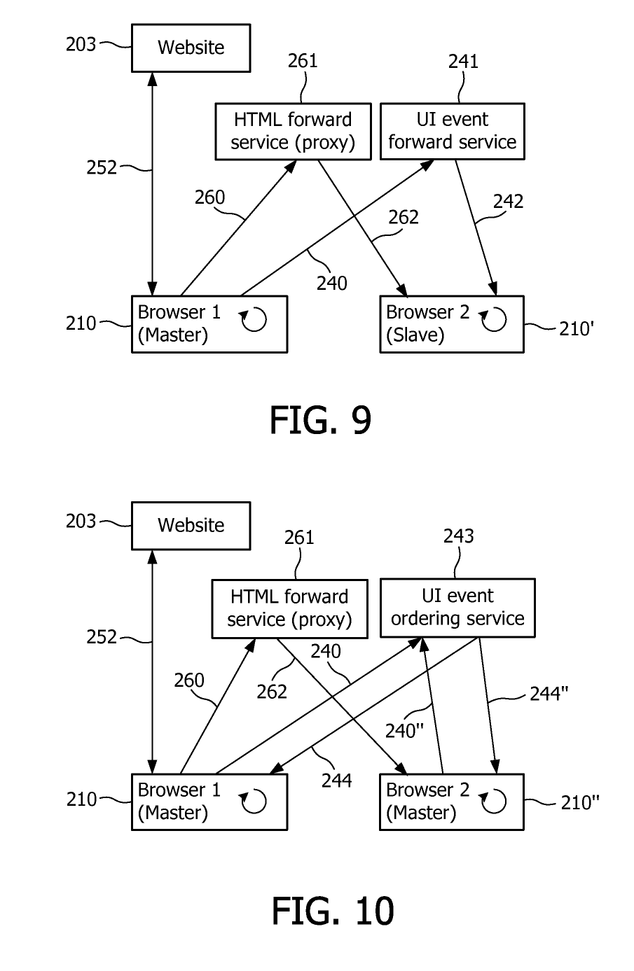

FIG. 9 illustrates a fourth embodiment of implementing the co-browsing system, which is based on UI event synchronization and a proxy server in JavaScript 261. This embodiment is the same as the third embodiment, except that the proxy functionality is now implemented in JavaScript on one of the co-browsers. This JavaScript code is preferably located in a different frame, or a communication frame, inside the browser. Every time a new page is loaded in the co-browsed frame of the “proxy browser” 210, the HTML 260 is sent to the proxy JavaScript code 261 that will send the HTML of this new page, as a forwarded HTML 262, to the other co-browser 210′. In these other co-browser, the communication frame will receive this HTML and use it to overwrite the document of the co-browsed frame. Note that also XMLHttpRequest application programming interface calls made by the co-browsed web application must be synchronized. This is done by redefining the XMLHttpRequest object in such a way that the calls are not directed to the web service any more but to the co-browse proxy component implemented in JavaScript on one of the browsers. The co-browse proxy will then make the requests to the co-browsed web service. It should be noted that this co-browse proxy in JavaScript is not a complete proxy, in the sense that it does not forward multimedia content like pictures, movies and audio. Such content still has to come directly form the co-browsed web service. However, multimedia content items like pictures, movies etc almost always have a unique URL.

FIG. 10 illustrates a version of the fourth embodiment, where two co-browsers act as master browsers 210, 210″. In this case UI events 240, 240″ are sent to a user interface event ordering service 243 which forwards the ordering UI events 244 to the first and second browser 210, 210″.

As an example of a preferred embodiment the option where co-browsing is achieved by synchronizing the JavaScript engines (via UI events synchronization) is further described. For ease of explanation the master-slave co-browsing solution is first described. Further below, it will be explained how this can be extended to peer co-browsing.

The co-browsing service consists conceptually of two sub services: a web proxy service and an event forwarding service. The role of the proxy service is to proxy HTTP requests from all browsers, i.e. all co-browsing browsers should receive exactly the same response for every URL request they send.

The proxy service processes each URL request conceptually as follows: For every request the proxy receives first, it must forward the request to the CE-HTML service, and return the response the requesting co-browsing client and store it in a cache for the other co-browsing clients. For all later requests by the other co-browsing clients, the proxy can retrieve the request from the cache and respond immediately. If all co-browsing CE-HTML clients have retrieved their response the response may be discarded from the cache. Note that a unique request is determined by the URL and the number of times this URL has been requested in the same session. Note that for web services that make use of cookies, the proxy must also determine whose cookies of the different co-browsers will be used.

To redirect the co-browser to use the web proxy service there are basically two options. One solution to change the proxy settings of the browsers. This means that the browser allows this to be set by privileged JavaScript code. Another way is for the proxy server to scan the downloaded pages and change every single URLs to point to the proxy web server. A third way is redefine the known XMLHttpRequest objects and to listen to all known “DOMactivates” events or “load” event, disabling the normal behavior of loading the page and load the same page via the proxy server. Note that also XMLHttpRequests need to be redirected to the web proxy service. A further task the proxy can perform is to inject the co-browsing agent JavaScript code in every page. A last task the proxy service can fulfill is to absolutise the HTML code to ensure that all the browsers will display the HTML in the same way.

The role of the UI event forwarding service is to allow the JavaScript in the two browsers to communicate with each other. This is because the JavaScript can only make outbound connections, either by using the widely used XMLHttpRequest object or the Notifsocket object specified by CE-HTML.

A number of variations are possible of which one is that the top frame of the browser consists of two sub-frames: one frame, which can be hidden, is for communication purposes and the other one is the frame which is shared and where the web service being co-browsed is shown. The communication frame also contains the necessary JavaScript code for co-browsing.

In brief, the JavaScript synchronization code on the master browser includes i) taking care that every HTML target has an unique id, after a new page has been loaded, ii) starting intercepting all JavaScript UI events, and iii) sending a description of every event to the slave browsers.

The JavaScript synchronization code on the slave browser includes i) taking care that every HTML target has an unique id, after a new page has been loaded and using the same scheme as used by the master browsers, ii) preventing all local user input, iii) starting receiving the event descriptions, and iv) for every event description received, recreating the corresponding JavaScript event and dispatch this event.

In more detail, the first step is to make sure that every HTML node in the HTML document has a unique identifier. Therefore a script is used that assigns an identifier to every node that hasn't one yet. This script is executed after the new page has been loaded, it is triggered by the load event. Note that user interactions that take place before the load function are not (always) transmitted. This is solved by preventing all default user actions when the page is loaded and allow them again only when the load event had occurred. All events defined in CE-HTML must be captured and sent over. These are the known DOM level 2 events (DOMFocusIn, DOMFocusOut, DOMActivate, mousedown, mouseup, click, mouseover, mousemove, mouseout, DOMSubtreeModified, DOMNodelnserted, DOMNodeRemoved, DOMNodeRemovedFromDocument, DOMNode-InstertedlntoDocument, DOMAttrModified, DOMCharacterDataModified), the key events (keydown, keyup, and keypress) and the HTML events (load, unload, abort, error, select, change, submit, reset, focus, blur, resize and scroll).

Capturing the UI events can be done by registering event handlers by means of the addEventListener( ) method provided by the DOM interface. Sending over an event can be done by first serializing the event into some XML string and by means of XMLHttpRequest.

FIG. 11 gives an example of the syntax of a mouse event description that is sent over to the slave browsers.

At the slave side, the events can be recreated and dispatched by means of the following DOM functions: document.createEvent(eventtype); document.initMouseEvent(event), document.initKeyEvent(event), document.initKeyEvent(event) and target.dispatchevent( ).

These functions cause the associated JavaScript event handlers to be called. This keeps the JavaScript engines in sync. However, recreating and dispatching an artificial JavaScript event does not always cause the associated default action to be executed. For example, manually firing a focus event on a page element does not cause the element to receive focus. The focus( ) method must be used for that. Likewise, manually firing a submit event does not submit a form (use the submit( ) method), In the case of UI events, this is important for security reasons, as it prevents scripts from simulating user actions that interact with the browser itself. The only actions that happen after manually firing an event is that the associated JavaScript event handlers will be called. Therefore also the default actions must be performed at the slave browsers.

Since the slave browsers must follow the master browser strictly the local user input must be disabled. This means that the default action of the browser should be blocked, e.g. loading of a new page when an anchor has been clicked, and that no JavaScript event handlers may be called. The former can be achieved by the use of the JavaScript function preventDefault( ). The preventDefault( ) function works only for events which are cancelable. To prevent JavaScript event handlers from processing an event, it is possible to use the stopPropagation( ) function, as shown by the code snippet in FIG. 12.

However, stopPropagation( ) will also block the events that should be injected into the page. Therefore when blocking the events, the events of the local UI, which must be blocked, must be distinguished from the events coming from the master browser and which a user injects.

To this end, an unused property of the event object can be used. This property is set for the events a user injects himself to a specific value and only these events are not stopped. For mouse events, this can be the “detail” property of the event object, i.e. “event.detail”, which represents in principle the number of mouse clicks on one pixel. It is not very likely that a web application will make use of this property. For key events, which do not have the detail property, the altkey or ctrlkey or metakey property could be used to make a difference between local UI events and artificially created events. Note that key events, which are not standardized, have no detail attribute. For the events, the known “event.cancelable” is used in the same way.

The simplest solution to master-master co-browsing is to allow switching between the master and the slave. For a solution based on UI event synchronization, this is readily realized. Switching only involves blocking the local UI events on the previous master and re-allowing the local UI events on the previous slave browsers, which then of course also redistribute these events.

For a solution based on DOM updates synchronization, switching is less trivial and there are actually two ways. The first is to make the new master browser also the reference browser. This involves sending over the complete state of the JavaScript engine together with the DOM to the new master browser. The other option is to keep one browser always as the reference browser and the master browser must than first send the UI events to this reference browser. The reference browser will then calculate the new DOM and redistribute it over the other co-browsing clients.

If a true master-master solution is required, all UI events must be ordered first. This means that all JavaScript UI events, happening on all browsers, must first be captured and send to a UI sync server, where the UI events are ordered on a first come first served basis. The ordered events are than all redistributed to all the co-browsers. This principle holds both for the UI event synchronization and the DOM synchronization solution. Note that in the DOM sync solution the synchronized events only need to be sent to the reference browser.

In general, the invention described here can be applied for co-browsing scripted web sites within a number of different application areas. As mentioned, the inventive method also applies to different HTML version, e.g. CE-HTML, which is HTML used in association with consumer devices. The co-browsing method may be used as an online shopping assistant tool, whereby an online shopping assistant can guide a potential customer through an online shop web site.

Considering a currently growing trend towards the browser being the platform for applications, e.g. web 2.0 and Ajax, potential application areas comprises online office tools, such as word, spreadsheet, powerpoint and picture editing. This also means that collaboration tools and shared applications are increasingly based on the browser platform. In this context, the inventive method may be used with benefit.

The inventive co-browsing solution can also be reused to synchronize java scripted HTML applications that have been designed with multiple users in mind. Such multi-user web applications typically contain one or more shared parts, which have the same view among all participants, along with some private parts with a different view. To synchronize these shared parts the co-browsing methods described in this invention can be reused.

Co-browsing can also be applied in personal healthcare applications where the nurse, located at the hospital, can guide a patient, located at home, through his medical measurements and help the patient with, for example, filling in questionnaires.

The method applies for every scripting language that makes changes to the HTML document through the DOM. An example of this is java applets. The inventive method is also relevant for co-browsing scripted SVG (scalable vector graphics) documents.

1. A method for collaboratively browsing the content of a dynamic electronic document in network comprising at least a first Web browser and a second Web browser, the method comprising the steps of:
retrieving, from a Web site, dynamic Web page content comprising at least one Web application script,
detecting a user input event in any of the browsers,
executing, in the first browser, a co-browsing script which includes generating an update message in dependence of the user input event, the update message representing an update of the Web page content,
sending, from the first browser to the second browser, the update message,
executing, in the first browser, the Web application script which includes updating the content of the electronic document in the first Web browser in dependence of the update message or the user input event, and
updating, in the second browser, the content of the electronic document in the second Web browser in dependence of the update message, so as to synchronize the Web page content of the first and second Web browser.

2. A method according to claim 1, wherein the content of the electronic document is represented by a Document Object Model, the update message comprising a Document Object Model update.

3. A method according to claim 2, wherein the first Web browser is a reference browser,
the step of detecting a user input event includes detecting the event in the second Web browser and sending it to the first Web browser,
the step of sending the update message includes sending the update message from the first browser to a third browser,
the step of updating the content of the electronic document in the second Web browser includes updating content of the electronic document in the third Web browser in dependence of the update message, so as to synchronize the Web page content of the first, second and third Web browser,
the updating of the content of the electronic document in the second and third Web browser includes updating the Document Object Model in dependence of the Document Object Model update message.

4. A method according to claim 3, wherein the step of detecting a user input event includes:
sending the detected user input event to an event ordering service, and
transferring, according to a synchronization scheme, the user input event to the first Web browser.

5. A method according to claim 2, wherein
the step of detecting the user input event includes detecting the event in the first Web browser,
the step of executing the Web application script includes updating the Document Object Model in the first Web browser, and
the step of updating the content of the electronic document in the second Web browser includes updating the Document Object Model in dependence of the update message.

6. A method according to claim 5, wherein the step of sending the update message from the first browser to the second browser includes sending the update message via a message forward service.

7. A method according to claim 1, wherein the update message comprises the user input event.

8. A method according to claim 7, the wherein the step of updating the graphical content in the second browser includes executing, in the second browser, the Web application script which includes updating the content of the electronic document in the second Web browser in dependence of the update message.

9. A method according to claim 8, wherein the steps of executing the Web application script comprise updating the Document Object Model in the first and second Web browser.

10. A method according to claim 8, wherein the step of sending the update message from the first browser to the second browser includes sending the update message via a message forward service.

11. A method according to claim 1, wherein the step of detecting a user input event includes:
sending the detected user input event to an event ordering service, and
transferring, according to a synchronization scheme, the user input event to the first Web browser and to the second Web browser.

12. A method according to claim 1, wherein the Web browsers are connected to the Web site via a proxy server.

13. A method according to claim 1, further comprising the step of sending, from the first browser to the second browser, markup language code describing the Web page content.

14. A method according to claim 1, further comprising the step of selectively disabling user input in one of the browsers.

15. A method according to claim 1, wherein the Web page comprises HTML nodes, the method further comprising the step executing a computer script configured to assign, to each HTML node, a unique identifier.
